(19) United States
(12) Patent Application Publication
(10) Pub. No.: US 2026/0288177 A1
(43) Pub. Date: Sep. 24, 2026

(54) Systems and Method for Controlling an Activability of a Vehicle Function

(71) Applicant: Bayerische Motoren Werke Aktiengesellschaft, Muenchen (DE)

(72) Inventors: Matthias FISCHER, Rohrbach (DE); Stefan JERG, Kranzberg (DE); Walter KAGERER, Muenchen (DE)

(21) Appl. No.: 19/478,390

(22) PCT Filed: Nov. 22, 2023
(86) PCT No.: PCT/DE2023/100907

§ 371 Date: Oct. 24, 2025

(30) Foreign Application Priority Data
Apr. 25, 2023 (DE) 10 2023 110 541.8

(51) Int. Cl. G05D 1/82; G05D 111/50

(52) U.S. Cl. CPC G05D 1/82; G05D 2111/58

(57) ABSTRACT

Please replace the original Abstract with the following:

A system for controlling an activability of a vehicle function of a vehicle is designed to detect a steering operation, to determine a steering wheel angular speed occurring during the steering operation and/or a steering angular speed and, depending on the determined steering wheel angular speed and/or the determined steering angular speed, to suppress the activability of the vehicle function by means of an operating element arranged on a steering wheel of the vehicle, for a period of time after the steering operation.

### BACKGROUND AND SUMMARY

The invention relates to systems and a method for controlling an activatability of a vehicle function. The invention relates in particular to controlling the activatability of an automated vehicle function which can normally be activated by means of an operator control element arranged on a steering wheel.

Driver assistance systems which provide automated driving functions are often activated and operated via steering wheel keys. For example, one or more operator control keys for activating or setting automated longitudinal and/or lateral guidance functions, such as adaptive cruise control (ACC) or a steering and lane guidance assistant, can be provided on the steering wheel.

If an automated driving function- or another type of vehicle function-can be activated by means of an operator control element on a steering wheel, it may result in unintended operator control actions if the driver's hand accidentally brushes the operator control element. For example, when maneuvering (for example when reverse parking), a driver may rest the heels of their hand on a steering wheel spoke and, in the process, press an operator control element. This can result in accidental activation of a vehicle function.

Conventional approaches for preventing accidental operation are in most cases based on design measures. For example, such operator control keys are specifically not positioned at the very outside of the steering wheel in order to reduce the likelihood of accidental operation. Bars or elevations can also be provided near the operator control keys so that the respective vehicle function for instance is not activated even if the driver's hand only lightly brushes or strokes the operator control key. The operator control elements or a controller connected downstream thereof can also be designed so that comparatively high actuation forces are required to trigger activation. Another option may be to provide suitable debounce times in the function. In other words, provision may be made for an operator control element to have to be actuated for a specific minimum duration so that a corresponding actuation signal results in activation of a corresponding vehicle function.

The aforementioned approaches to solving the problems that are known in the prior art are associated with disadvantages: design measures of the type described above may also make desired operation more difficult. Debounce times may not reliably prevent accidental operation since accidental operation may also occur with longer actuation times.

It is an object of the present invention to specify systems and methods for controlling an activatability of a vehicle function that make it possible to avoid accidental activation of the vehicle function, in particular in parking, maneuvering and turning situations, without making intended operator control actions more difficult at the same time.

The object is achieved by the subject matter of the independent patent claims. Advantageous embodiments are specified in the dependent patent claims.

It is pointed out that additional features of a patent claim dependent on an independent patent claim may form a specific invention that is independent of the combination of all of the features of the independent patent claim without the features of the independent patent claim or only in combination with some of the features of the independent patent claim, which invention may form the subject matter of an independent patent claim, of a divisional application or of a subsequent application. This applies analogously to technical teaching described in the description, which teaching may form an invention that is independent of the features of the independent patent claims.

A first aspect of the invention and a second aspect of the invention each relate to a system for controlling an activatability of a vehicle function of a vehicle.

The vehicle may be, in particular, a motor vehicle. The term motor vehicle is intended to be understood as meaning, in particular, a land vehicle that is moved by machine power without being tied to tracks. A motor vehicle in this sense may be, for example, in the form of an automobile, a motorcycle or a tractor.

The vehicle function may be, for example, an automated driving function that is available as part of a driver assistance system of the vehicle. In particular, the vehicle function may be an automated driving function that is set up for at least partly automated longitudinal and/or lateral guidance during driving operation of the vehicle. Examples of this are a dynamic cruise control (DCC) system, an adaptive cruise control (ACC) system, and a steering and lane guidance assistant.

The term “automated driving function” in the context of this documents generally denotes a vehicle function that enables automated driving. The term “automated driving” is understood to mean driving with automated longitudinal and/or lateral guidance. Automated driving may involve, for example, driving on the freeway for a longer period of time or driving for a limited period of time during parking. The term “automated driving” comprises automated driving with any degree of automation. Illustrative degrees of automation are assisted, partially automated, conditionally automated, highly automated and fully automated driving (with an increasing degree of automation in each case). The aforementioned five degrees of automation correspond to SAE levels 1 to 5 of the SAE J3016 (SAE—Society of Automotive Engineering) standard in the version dated Apr. 30, 2021. In assisted driving (SAE level 1), the system performs the longitudinal or lateral guidance in certain driving situations with the expectation that the driver takes over all remaining aspects of the dynamic driving tasks. In partially automated driving (SAE level 2), the system takes over the longitudinal and lateral guidance in certain driving situations, the driver needing to constantly monitor the system as in the case of assisted driving. In conditionally automated driving (SAE level 3), the system takes over the longitudinal and lateral guidance in certain driving situations without the driver having to constantly monitor the system; the driver must be able to take over the vehicle guidance within a certain time at the request of the system, however. In highly automated driving (SAE level 4), the system takes over the vehicle guidance in certain driving situations, even if the driver does not react to a request for intervention, and so the driver is dispensed with as a fallback level. In fully automated driving (SAE level 5), the system may perform all aspects of the dynamic driving task which are also handled by a human driver under any road and environmental condition.

The system according to the first aspect of the invention is set up to detect a steering actuation, to determine a steering wheel angular velocity and/or a steering angle velocity occurring during the steering actuation and, depending on the determined steering wheel angular velocity and/or the determined steering angle velocity, to suppress the activatability of the vehicle function by means of an operator control element arranged on a steering wheel of the vehicle for a defined period of time after the detected steering actuation.

The system according to the second aspect of the invention is set up to detect a steering actuation, to determine a steering wheel angle and/or a steering angle occurring during the steering actuation and, depending on the determined steering wheel angle and/or the determined steering angle, to suppress the activatability of the vehicle function by means of an operator control element arranged on a steering wheel of the vehicle for a period of time after the steering actuation.

A hybrid of the systems according to the first aspect of the invention and the second aspect of the invention is also possible, that is to say, for example, a system according to the first aspect of the invention that is additionally set up to determine a steering wheel angle and/or a steering angle occurring during the steering actuation and, depending on the determined steering wheel angle and/or the determined steering angle, to suppress the activatability of the vehicle function by means of an operator control element arranged on a steering wheel of the vehicle for a period of time after the steering actuation. In such a hybrid, it is thus possible to link conditions for suppressing the activatability of the vehicle function both to the steering (wheel) angle and to the steering (wheel) angular speed. In particular, these may be linked by a logical “or”, such that the activatability of the vehicle function is suppressed if a condition relating to the steering (wheel) angle or a condition relating to the steering (wheel) velocity is met. Such conditions may relate, in particular, to threshold value criteria, as will be explained in more detail below.

In forms of systems according to the invention, the intention is thus to suppress a normally existing option for activating the vehicle function by means of the operator control element, for example a steering wheel operator control key, depending on the determined steering wheel angular velocity and/or the determined steering angle velocity and/or the determined steering wheel angle and/or the determined steering angle (as an exception) for a certain period of time. For example, in the event of an attempted activation, (suppressed according to the invention), the driver receives an operator control feedback message stating the activation of the vehicle function is not possible. In this case, the invention is based on the knowledge that significantly greater steering wheel angular velocities and steering angle velocities and/or greater steering wheel angles and steering angles typically occur during parking and maneuvering and during sharp turns, that is to say in situations in which, empirically, inadvertent misactivations of vehicle functions by means of steering wheel operator control elements increasingly occur than is the case in normal driving operation. The steering wheel angular velocity and steering angle velocity and/or the steering wheel angle and steering angle can therefore be used as an indication of the existence of such a situation and the activatability of the relevant vehicle function can specifically be suppressed for a predetermined period of time in order to preclude inadvertent activation from the outset.

In the context of the present document, the steering wheel angular velocity is to be understood as meaning the angular velocity with which the steering wheel of the vehicle is rotated. This variable is thus independent of any steering ratio. In contrast, in the context of the present document, the steering angle velocity is intended to refer to the steering angle velocity (that is to say the time derivative of the steering angle) according to a steering ratio by a steering gear of the vehicle. Typical steering ratios are in the range of from 14:1 to 20:1. A steering angle velocity arising as a result of a particular steering wheel angular velocity is accordingly typically significantly lower than this steering wheel angular velocity. However, both variables are suitable in principle to the same extent for identifying a situation in the context of the system according to the invention in which a temporal suppression of the activatability of the vehicle function is applicable. In this case, the steering actuation per se can also be detected according to some embodiments based on an ascertained steering wheel angular velocity and/or based on an ascertained steering angle velocity. In this respect, the steering actuation does not have to be detected as a separate step.

In the context of the present document, the steering wheel angle is to be understood as meaning an angle by which the steering wheel is turned with respect to a straight-ahead position of the steering wheel. This variable is thus independent of any steering ratio. In contrast, according to the conventional understanding of a person skilled in the art, the term “steering angle” relates to an orientation of a steered axle with respect to a position when driving straight ahead. The steering angle is conventionally a function of the steering wheel angle, with the correlation between both variables being given by the steering ratio. The steering (wheel) angle can be determined, for example, by means of a steering (wheel) angle sensor in a manner known per se.

A system according to the first aspect of the invention may be set up, for example, to ascertain that the magnitude of the steering wheel angular velocity exceeds a steering wheel angular velocity threshold value and/or that the magnitude of the steering angle velocity exceeds a steering angle velocity threshold value and, depending on the ascertained circumstances that the magnitude of the steering wheel angular velocity exceeds the steering wheel angular velocity threshold value and/or that the magnitude of the steering angle velocity exceeds the steering angle velocity threshold value, to suppress the activatability of the automated driving function by means of the operator control element for a period of time after the steering actuation.

In an analogous manner, a system according to the second aspect of the invention may be set up to ascertain that the magnitude of the steering wheel angle exceeds a steering wheel angle threshold value, which may be, for example, at least 70° or at least 90°, and/or that the magnitude of the steering angle exceeds a steering angle threshold value and, depending on the ascertained circumstance that the magnitude of the steering wheel angle exceeds the steering wheel angle threshold value and/or that the magnitude of the steering angle exceeds the steering angle threshold value, to suppress the activatability of the vehicle function by means of the operator control element for a period of time after the steering actuation.

Hybrids are also possible, in which both a threshold value comparison with respect to the steering (wheel) angle and a threshold value comparison with respect to the steering (wheel) angular velocity is carried out, with the activatability of the vehicle function by means of the operator control element being suppressed for a period of time after the steering actuation if at least one of the mentioned variables (in terms of magnitude) exceeds a threshold value associated therewith.

Taking into account the magnitude of the steering wheel angular velocity as a relevant variable of the threshold value comparison also includes detecting (high, in terms of magnitude) negative steering (wheel) angular velocities that can arise, for example, in the event of a steering movement to the right in accordance with a usual sign convention. For example, in a specific software implementation, first the magnitude of the steering (wheel) angular velocity can be formed, and this can then be compared with a positive steering (wheel) angular velocity threshold value. In another implementation variant, a case differentiation can be carried out according to the sign of the steering (wheel) angular velocity, according to which a positive steering (wheel) angular velocity is compared with a positive steering (wheel) angular velocity threshold value, with the activation suppression being triggered if the threshold value is exceeded, and a negative steering (wheel) angular velocity is compared with a negative steering (wheel) angular velocity threshold value, with the activation suppression being triggered if the threshold value is undershot. As a result, in both implementation variants mentioned here by way of example, in the sense of the wording in the preceding paragraph and the corresponding patent claims, respectively, the magnitude of the steering (wheel) angular velocity is compared with a (positive) steering (wheel) angular velocity threshold value and, if applicable, it is ascertained that the magnitude of the steering (wheel) angular velocity exceeds the steering (wheel) angular velocity threshold value. The same applies to taking into account the magnitude of the steering angle or the steering wheel angle.

If a steering wheel angular velocity threshold value is used in the threshold value comparison, it may be selected, for example, such that it is at least 50°/s or even at least 100°/s. In particular, a steering wheel angular velocity threshold value in the range of from 50°/s to 250°/s, preferably in the range of from 100°/s to 200°/s, for example 180°/s, can be provided.

If the threshold value comparison is carried out based on a steering angle velocity threshold value, it may be selected, for example, such that it is at least 2.5°/s or at least 7°/s. In particular, the steering angle velocity threshold value may be in the interval from 2.5°/s to 18°/s, for example in the range of from 7°/s to 15°/s.

According to one embodiment, the time interval during which the activatability of the vehicle function is suppressed can directly follow the determination that the magnitude of the steering (wheel) angular velocity exceeds the steering (wheel) angular velocity threshold value and/or that the magnitude of the steering (wheel) angle exceeds the steering (wheel) angle threshold value. In other words, a timer can start with the ascertaining of the exceeding of the threshold value and run for the duration of the predetermined time interval. Only after the timer has expired can the vehicle function be reactivated by means of the operator control element. According to one variant, however, it is also possible that the activatability of the vehicle function is firstly suppressed until the magnitude of the steering (wheel) angular velocity exceeds the steering (wheel) angular velocity threshold value and/or the magnitude of the steering (wheel) angle exceeds the steering (wheel) angle threshold value and that the time interval starts as soon as the exceeding of the threshold value is no longer ascertained. The time interval can thus define a particular stopping time of the suppression of the activatability of the vehicle function after an ascertained exceeding of the threshold value of the steering (wheel) angular velocity or the steering (wheel) angle has been ascertained or has ended. The provision of such a stopping time may be expedient in order to also cover, for example in parking or maneuvering procedures, a period of time in which a change from a rapid rotation to the left to a rapid rotation to the right (or vice versa) of the steering wheel can be ascertained. In such a period of time, unusually high steering angle velocities or steering wheel angle velocities are not expected per se. However, in such a situation, it is expedient to continue to suppress the activatability during this transition phase from turning to the right to turning to the left as well.

In one embodiment, provision is made for the time interval during which the activatability of the vehicle function remains suppressed to have a duration of at least 0.5 s. Provision may be made, for example, for the time interval to have a duration in the range of from 0.5 to 5 s, in particular in the range of from 1 s to 3 s, example 1.5 s. With a duration of the stopping time selected in this way, it is possible to address transition phenomena, for example the aforementioned change from steering to the left to steering to the right when parking or maneuvering, that is to say it can be ensured that the vehicle function is not incorrectly operated even in such situations.

According to one advantageous development, the system is set up to suppress the activatability of the vehicle function by means of the operator control element depending on a velocity of the vehicle (in addition to the dependency on the steering (wheel) angular velocity and/or the steering (wheel) angle). In this case, the system may be set up, in particular, to ascertain that the velocity of the vehicle is not greater than a velocity threshold value and to suppress the activatability of the vehicle function by means of the operator control element depending on the ascertained circumstance that the velocity of the vehicle is not greater than a -preferably positive-velocity threshold value. The velocity threshold value may be selected, for example, such that it is 30 km/h or less, for example at most 15 km/m. The velocity threshold value is preferably selected such that it is in the interval of 5 km/h to 30 km/h or in the interval of 5 km/h to 15 km/h, for instance 8 km/h.

The idea of additionally using a velocity threshold value comparison when making a decision regarding the suppression of the activatability of the vehicle function is based on the insight that the aforementioned situations in which, empirically, vehicle functions are accidentally activated by means of steering wheel operator control elements (for example parking, maneuvering or sharp turning procedures) are typically associated with relatively low driving velocities, which are situated in the aforementioned velocity ranges, for instance. It is thus possible, for example, to identify such situations based on the combined criteria of steering (wheel) angular velocity, steering (wheel) angle and (driving) velocity. In other words, an unintended activation of a vehicle function can specifically be prevented when a rapid steering movement and/or a high steering lock is identified while the vehicle is driving slowly. As mentioned above, it is then possible to suppress an activatability of the vehicle function for the duration of a determined stopping time after this situation has been identified.

According to one embodiment variant, the suppression of the activatability of the vehicle function may (also) depend on the velocity of the vehicle in such a way that the steering (wheel) angular velocity threshold value and/or the steering (wheel) angle threshold value, with the exceeding of which the activation to be suppressed, is set depending on the velocity of the vehicle. In this case, the velocity dependency of the threshold values can be designed, in particular, such that the respective threshold value is lower, the higher the driving velocity of the vehicle. In the case of high velocities, lower steering (wheel) angles and steering (wheel) angular velocities usually arise since fewer rapid longitudinal maneuvers are desired. In this respect, it is expedient for the threshold values to be lower in the case of higher velocities. For example, a reverse proportional correlation between the driving velocity of the vehicle and the steering (wheel) angular velocity threshold value or the steering (wheel) angle threshold value would be conceivable.

The invention also includes the fact that the system may be set up to suppress the activatability of the vehicle function by means of the operator control element depending on at least one additional detected circumstance indicating that the vehicle is in a parking, maneuvering or turning situation, with the at least one detected circumstance being selected from the list comprising the following: an activation (that is to say, for example, an actuation or an activated state) of a turn indicator; a switching from reverse gear to a forward gear, in particular to first gear, or vice versa;
a spatial proximity of the vehicle to one or more objects or obstacles, in particular to one or more stationary vehicles; a spatial proximity of the vehicle to a bend or intersection identified in an environment model and/or based on map information; a spatial proximity to a parking space identified in an environment model; an activation (that is to say, for example, a switch-on or an activated state) of a parking assistance function and/or a parking view in a visual information display of the vehicle, such as in an instrument cluster. In this case, it is possible to classify the fact that such a circumstance is detected in a defined temporal proximity to the detected steering actuation as a prerequisite for suppressing the activatability of the vehicle function. In this way, a relevant situation in which suppression of the activated of the vehicle function by means of the operator control element on the steering wheel is applicable can be identified even more reliably and in a more targeted manner.

A third aspect of the invention is a method for controlling an activatability of a vehicle function of a vehicle, the method comprising the following steps: detecting a steering actuation, in particular by means of a steering wheel of the vehicle; determining a steering wheel angular velocity occurring during (or as a result of) the steering actuation and/or a steering angle velocity and/or a steering wheel angular velocity occurring during the steering actuation; and, depending on the determined steering wheel angular velocity and/or on the determined steering angle velocity and/or on the determined steering wheel angle and/or on the determined steering angle, suppressing he activatability of the vehicle function by means of an operator control element arranged on a steering wheel of the vehicle for a period of time after the steering actuation.

The method according to the third aspect of the invention may be able to be carried out by means of a system according to the first or second aspect of the invention. The explanations above and below relating to the systems according to the invention and to the possible configurations thereof can be understood analogously for the method according to the invention and vice versa.

Systems according to the invention may comprise, for example, a (data) processing device having at least one processor and being set up to carry out the method according to the first aspect of the invention by means of the at least one processor. According to some embodiments, this may also be a spatially (for example over multiple processors or microcontrollers spaced apart from one another) distributed processing device.

For example, the processing device may be a control unit or a part of a control unit of the vehicle, in particular a control unit for controlling the vehicle function, for example an automated driving function.

A fourth aspect of the invention is a computer program comprising commands which, when the computer program is executed by a processing device (for example a processing device of a system according to the first or second aspect of the invention) cause the processing device to carry out a method according to the third aspect of the invention. In this case, the computer program may be distributed across multiple separate subprograms, which may each be executed by different processing devices that may be physically remote from one another (for example by multiple separate processors).

A processing device of a system according to the first or second aspect of the invention may be set up (in particular programmed) to execute a computer program according to the fourth aspect of the invention.

A fifth aspect of the invention is a computer-readable storage medium comprising commands which, when executed by a (possibly distributed) processing device, cause this processing device to carry out a method according to the third aspect of the invention. In other words, a computer program according to the fourth aspect of the invention can thus be stored on the computer-readable storage medium.

A sixth aspect of the invention is a vehicle, in particular a motor vehicle, having a system according to the first or second aspect of the invention.

The invention will now be explained in more detail on the basis of exemplary embodiments and with reference to the accompanying drawings. In this case, the features and combinations of features mentioned above or below in the description and/or shown on their own in the drawings may be used not only in the respectively indicated combination but also in other combinations or on their own without departing from the scope of the invention.

### BRIEF DESCRIPTION OF THE DRAWINGS

FIG. 1 schematically illustrates by way of example a system for controlling an activatability of a vehicle function.

FIG. 2 schematically illustrates by way of example steps of a method for controlling an activatability of a vehicle function.

### DETAILED DESCRIPTION OF THE DRAWINGS

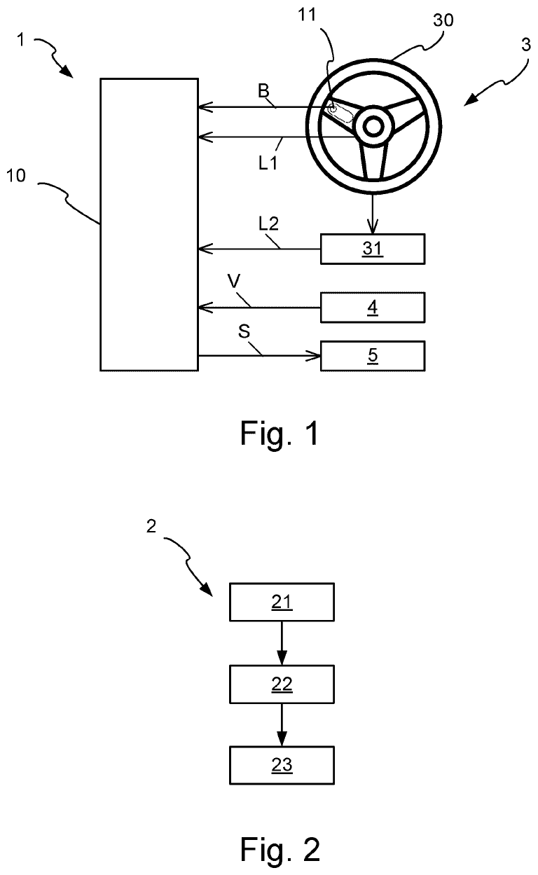

A system 1, schematically illustrated in FIG. 1, for controlling an activatability of a vehicle function is explained below with reference to steps 21 to 23 of a method 2 for controlling an activatability of a vehicle function, the method being illustrated in FIG. 2 in the form of a block diagram.

FIG. 1 shows a steering system 3 having a steering wheel 30 and a steering gear 31. FIG. 1 also shows a system 1 for controlling an activatability of a vehicle function, with the system 1 comprising an operator control element 11 arranged on a steering wheel spoke and a (data) processing device 10. The processing device 10 is connected to the operator control element 11 for signal transfer purposes and is set up to receive an actuation signal B when the operator control element 11 is actuated.

The processing device 10 is connected to the steering wheel 30 for signal transfer purposes and is set up to receive a steering wheel angle signal L1 from the steering wheel, which signal indicates a steering wheel angle. As an alternative or in addition thereto, the processing device 10 may also be set up to receive a steering angle signal L2 from the steering gear 31. The steering angle signal L2 indicates a steering angle resulting from the steering wheel angle set at the steering wheel according to the steering ratio by means of the steering gear 31.

The system 1 is set up to carry out the method steps 21 to 23 according to FIG. 2 by means of the processing device 10.

In a method step 21, the processing device 10 detects a steering actuation of the steering wheel 30. For example, the steering actuation can be detected based on the steering wheel angle signal L1 and/or based on the steering wheel signal L2, for example in the case of an ascertained change in the steering (wheel) angle.

In a method step 22, which may also coincide with method step 21 in some embodiments, the processing device 10 determines a steering wheel angular velocity occurring during the steering actuation and/or steering angle velocity and/or a steering wheel angle occurring during the steering actuation and/or steering angle. The determination of the steering (wheel) angle may also consist, for example, simply in the reception of a corresponding value that is transmitted by the steering wheel angle signal L1 or by the steering angle signal L2. The steering wheel angular velocity can be calculated as a temporal derivative of the steering wheel angle transmitted by the steering wheel angle signal L1. The steering angle velocity can be calculated analogously as a temporal derivative of the steering angle transmitted by the steering angle signal L2.

In another method step 23, the activatability of a vehicle function by means of the operator control element 11 is suppressed depending on the determined steering wheel angular velocity and/or the determined steering angle velocity and/or the determined steering wheel angle and/or the determined steering angle for a defined period of time after the steering actuation. In the exemplary embodiment shown in FIG. 1, the processing device 10 is used specifically at the same time as the control apparatus for the vehicle function, which may be in particular, an automated driving function such as adaptive cruise control, dynamic cruise control or a steering and lane guidance assistant. In this case, in the event of an actuation of the operator control element 11, that is to say when the processing device 10 receives an actuation signal B, the processing device 10 is set up to output a control signal S, depending on the actuation signal B, to a downstream function apparatus 5, which implements the vehicle function. In other words, the processing device 10 can normally activate the vehicle function upon reception of the actuation signal B by outputting the control signal S to the function apparatus 5. However, if the activatability of the vehicle function is suppressed depending on the steering wheel angular velocity and/or the steering angle velocity and/or the determined steering wheel angle and/or the determined steering angle, no control signal S for activating the function component 5 is output for a particular period of time, which may be 0.5 s or longer, for example, even if an actuation signal B is received during this period of time. In such a case, instead of the vehicle function being activated, a piece of information can optionally be output to a driver of the vehicle in order to make them aware of the fact that the vehicle function is not activatable in the present situation. Provision may thus be made for a negative feedback message to be passed to the driver regarding their operator control action for activating vehicle function.

In some implementations, method step 23 comprises a threshold value comparison with respect to the determined steering wheel angular velocity and/or with respect to the determined steering angle velocity. This means that the system 1 is set up to ascertain that the magnitude of the steering wheel angular velocity exceeds the steering wheel angular velocity threshold value and/or that the magnitude of the steering angle velocity exceeds a steering angle velocity threshold value and, depending on the ascertained circumstance that the magnitude of the steering wheel angular velocity exceeds the steering wheel angular velocity threshold value and/or that the magnitude of the steering angle velocity exceeds steering angle velocity threshold value for the defined period of time, to suppress the activated of the vehicle function. For example, the steering wheel angular velocity threshold value may be 50°/s or more and the steering angle velocity threshold value may be, for example, 2.5°/s or more.

In the exemplary embodiment according to FIG. 1, the processing device 10 is also connected to an odometry unit 4 of the vehicle for signal transfer purposes. The processing device 10 can receive a velocity signal V from the odometry unit 4. The processing device 10 is set up to also take into account the current velocity of the vehicle in addition to the steering (wheel) angular velocity and/or the steering (wheel) angle when deciding whether the activatability of the vehicle function should be suppressed. In particular, the processing device 10 can also use the velocity signal to ascertain that the velocity of the vehicle is not greater than a (preferably positive) velocity threshold value and additionally to suppress the activatability of the vehicle function by means of the operator control element 11 depending on the ascertained circumstance that the velocity of the vehicle is not greater than the velocity threshold value. For example, the velocity threshold value may be selected so that it is at most 30 km/h.

It is possible to identify parking, maneuvering or turning situations in which, empirically, the risk of inadvertent activation of a vehicle function, for example an automated driving function, by means of a steering wheel operator control key 11 often occurs by considering in combination the steering wheel angular velocity and/or steering angle velocity and/or steering wheel angle and/or steering angle on the one hand and the velocity of the vehicle on the other hand. Targeted suppression of the activatability of the relevant driving function for a certain period of time can be used in such situations to preclude incorrect operation from the outset. In contrast, according to one advantageous embodiment, provision may be made for the deactivation of the vehicle function by means of the operator control element 11 to always be possible irrespective of the steering (wheel) angle, the steering (wheel) angular velocity and the velocity of the vehicle.

In addition to the steering (wheel) angle and/or the steering (wheel) angular velocity and, if applicable, the velocity of the vehicle, the processing device 10 can use additional information to identify such relevant situations in which suppression of the activatability of the vehicle function by means of the operator control element 11 is applicable in an even more reliable and accurate manner. For example, the processing device 10 can receive an actuation signal of a turn indicator and make the suppression of the activatability of the turn indicator dependent on the identified activation of the turn indicator identified in such a manner. An activated turn indicator (blinker) can be classified specifically as an additional indication of a parking, maneuvering or turning maneuver. In a similar manner, activation of a parking assistance function and/or a parking view in a visual information display of the vehicle detected by the processing device 10 can be classified as an indication for a parking situation and can be taken into account in the decision as to whether the activatability of the vehicle function should be suppressed. It is also conceivable that the processing device 10 obtains information from an environment model, which is generated or used, for example, within a driving assistance function of the vehicle. The processing device 10 can derive from this, for example, a spatial proximity of the vehicle to one or more objects or obstacles, in particular stationary vehicles, which in turn can indicate a parking situation. It is also possible that environment model information relating to a parking space identified in the vehicle surroundings or a detected switching from reverse gear to first gear or vice versa are classified by the processing device 10 as indications of the existence of a parking or maneuvering situation. It is also conceivable that a spatial proximity of the vehicle to a turn or intersection identified in an environment model or based on map information is detected as a circumstance that is taken into account by the processing device 10 when deciding about the suppression of the activatability of the vehicle function.

1.-13. (canceled)

14. A system for controlling an activatability of a vehicle function of a vehicle, the system comprising:
one or more processors configured to:
detect a steering actuation;
determine a steering wheel angular velocity occurring during at least one of the steering actuation or a steering angle velocity; and,
depending on the determined at least one of steering wheel angular velocity or the determined steering angle velocity, suppress the activatability of the vehicle function by means of an operator control element arranged on a steering wheel of the vehicle for a period of time after the steering actuation.

15. The system according to claim 14, wherein the one or more processors of the system are configured to:
ascertain that at least one of a magnitude of the steering wheel angular velocity exceeds a steering wheel angular velocity threshold value or that the magnitude of the steering angle velocity exceeds a steering angle velocity threshold value; and,
depending on ascertained circumstance that at least one of the magnitude of the steering wheel angular velocity exceeds the steering wheel angular velocity threshold value or that the magnitude of the steering angle velocity exceeds a steering angle velocity threshold value, suppress the activatability of the vehicle function by means of the operator control element for a period of time after the steering actuation.

16. The system according to claim 15, wherein the one or more processors of the system are configured to:
ascertain that the magnitude of the steering wheel angular velocity exceeds a steering wheel angular velocity threshold value of at least 50°/s; and
depending on the ascertained circumstance that the magnitude of the steering wheel angular velocity exceeds the steering wheel angular velocity threshold value, suppress the activatability of the vehicle function by means of the operator control element for a period of time after the steering actuation.

17. The system according to claim 15, wherein the one or more processors of the system are configured to:
ascertain that the magnitude of the steering angle velocity exceeds a steering angle velocity threshold value of at least 2.5°/s; and
depending on the ascertained circumstance that the magnitude of the steering angle velocity exceeds the steering angle velocity threshold value, suppress the activatability of the vehicle function by means of the operator control element for a period of time after the steering actuation.

18. The system according to claim 14, wherein the one or more processors of the system are configured to:
determine at least one of a steering wheel angle or steering angle occurring during the steering actuation; and
depending on the at least one of the determined steering wheel angle or the determined steering angle, suppress the activatability of the vehicle function by means of the operator control element arranged on the steering wheel of the vehicle for a period of time after the steering actuation.

19. A system for controlling an activatability of a vehicle function of a vehicle, the system comprising:
one or more processors configured to:
detect a steering actuation;
determine at least one of a steering wheel angle or steering angle occurring during the steering actuation; and
depending on the at least one of the determined steering wheel angle or the determined steering angle, suppress the activatability of the vehicle function by means of an operator control element arranged on a steering wheel of the vehicle for a period of time after the steering actuation.

20. The system according to claim 19, wherein the one or more processors are configured to:
ascertain that at least one of a magnitude of the steering wheel angle exceeds a steering wheel angle threshold value or that the magnitude of the steering angle exceeds a steering angle threshold value; and
depending on the ascertained circumstance that at least one of the magnitude of the steering wheel angle exceeds the steering wheel angle threshold value or that the magnitude of the steering angle exceeds the steering angle threshold value, suppress the activatability of the vehicle function by means of the operator control element for a period of time after the steering actuation.

21. The system according to claim 19, wherein the vehicle function is an automated driving function.

22. The system according to claim 19, wherein the one or more processors of the system are further configured to suppress the activatability of the vehicle function by means of the operator control element depending on a velocity of the vehicle.

23. The system according to claim 22, wherein at least one of:
at least one of the steering wheel angular velocity threshold value or the steering angle velocity threshold value are dependent on the velocity of the vehicle; or
at least one of the steering wheel angle threshold value or the steering angle threshold value are dependent on the velocity of the vehicle.

24. The system according to claim 22, wherein the one or more processors of the system are configured to:
ascertain that the velocity of the vehicle is not greater than a velocity threshold value; and
suppress the activatability of the vehicle function by means of the operator control element depending on the ascertained circumstance that the velocity of the vehicle is not greater than the velocity threshold value.

25. The system according to claim 19, wherein the one or more processors of the system are further configured to suppress the activatability of the vehicle function by means of the operator control element depending on at least one detected circumstance which indicates that the vehicle is in a parking, maneuvering or turning situation, wherein the at least one detected circumstance comprises at least one of:
an activation of a turn indicator;
a switching from reverse gear to a forward gear or vice versa;
a spatial proximity of the vehicle to one or more objects or obstacles;
a spatial proximity of the vehicle to a bend or intersection identified in an environment model and/or based on map information;
a spatial proximity of the vehicle to a parking space identified in an environment model; or
an activation of a parking assistance function and/or a parking view in a visual information display of the vehicle.

26. A method for controlling an activatability of a vehicle function of a vehicle, the method comprising steps of:
detecting a steering actuation;
determining at least one of a steering wheel angular velocity occurring during the steering actuation, a steering angle velocity, or a steering wheel angular velocity occurring during the steering actuation; and
depending on the at least one of the determined steering wheel angular velocity, the determined steering angle velocity, the determined steering wheel angle, or the determined steering angle, suppressing the activatability of the vehicle function by means of an operator control element arranged on a steering wheel of the vehicle for a period of time after the steering actuation.
